(19) United States
(12) Patent Application Publication
(10) Pub. No.: US 2015/0102150 A1
(43) Pub. Date: Apr. 16, 2015

(54) JAW CRUSHER SUPPORT FRAME

(71) Applicant: SANDVIK INTELLECTUAL PROPERTY AB, Sandviken (SE)

(72) Inventors: Marten Lindberg, Malmo (SE); Karin Ljunggren, Limhamm (SE); Roger Sjobeck, Malmo (SE)

(21) Appl. No.: 14/404,036

(22) PCT Filed: May 7, 2013
(86) PCT No.: PCT/EP2013/059424

§ 371 Date: Nov. 26, 2014

(30) Foreign Application Priority Data
May 31, 2012 (EP) 12170245.0

(51) Int. Cl. B02C 1/10

(52) U.S. Cl. CPC B02C 1/10
USPC 241/262; 241/285.1

(57) ABSTRACT

A jaw crusher support frame having a frame plate bordered by a pair of side walls that extend lengthwise along the frame plate, the support frame being strengthened and stiffened by a saddle that projects rearwardly from the support frame between the pair of side walls.

### FIELD OF INVENTION

The present invention relates to a jaw crusher and in particular, although not exclusively, to a jaw support frame having a stiffening saddle extending between a pair of side walls.

### BACKGROUND ART

Jaw crusher units typically comprise a fixed jaw and a moveable jaw that define a crushing zone therebetween and a drive mechanism operative to rock the moveable jaw back and forth in order to crush material in the crushing zone.

The crushing zone defined between the fixed jaw and the moveable jaw is generally convergent towards its lower discharge end so that crushable material fed to the upper and wider end of the zone is then capable of falling downward under gravity whilst being subject to repeated cycles of crushing movement in response to the cyclical motion of the moveable jaw. The crushed material is then discharged under gravity through the narrower lower discharge end onto a conveyor belt for onward processing or final discharge from the crusher unit to a suitable stock pile.

To protect the main operative components of the crusher, replaceable wear plates are typically fitted to the impact or crushing faces of the fixed and moveable jaws. With the aim of reducing the overall weight of the crusher whilst ensuring components are sufficiently robust to withstand the significant stresses resultant from the crushing operation, the jaw support frames, that mount the wear plates, are typically formed from substantially planar frame plates bordered at each lengthwise side by a pair of rearwardly projecting side walls. To maximise the effectiveness of the crushing action, the wear plate support frames are stiffened with widthwise extending stiffening bridges that traverse the frame plate at its rearward side between the rearwardly projecting side walls.

Example jaw crushers fitted with stiffened wear plate support frames are described in U.S. Pat. No. 2,465,607; U.S. Pat. No. 3,153,512 and WO 2008/046127.

Conventionally, the wear plates are secured to the support frames via a compression wedge and a support bar, the support bar being secured to the frame by bolts received in bore holes extending through the respective support bar and support frame. Typically, the bolts are secured at the rearward facing side of the frame using a nut and a suitable seating member including for example a compression washer, spring or deformable collar. Typically, to facilitate machining at the rear surface of the frame around the bore holes, an elevated, rearwardly projecting cross bar extends over the region of the bore holes. However, inclusion of this cross bar compromises the general objective to reduce the weight of the crusher as much as possible.

What is required therefore is a jaw crusher and in particular a support frame that addresses the above problem.

### SUMMARY OF THE INVENTION

Accordingly, one objective of the present invention is to provide a jaw crusher support frame that is optimised for stiffness and weight reduction so as to positively affect the crushing efficiency of the jaw crusher in use and to increase longevity of the working components and in particular the wear parts.

The objective is achieved by a stiffening saddle that extends over a rear face of the support frame. The stiffening saddle comprises a dual function in order to maximise utilisation of the net increase in weight of the crusher. In particular, the stiffening saddle acts firstly to provide a strengthening support at the region of the bore holes to receive the anchorage bolts that mount the wear plate support member (or support bar). Secondly, by using the stiffening saddle to connect the side walls to form a support bridge, at the rear face of the support frame and at the region of the bore holes, the entire jaw assembly is stiffened. Further advantages of the present configuration are that the stiffening saddle maybe provided at either or both the fixed and moveable jaws and the machining of the region around the bore holes is greatly facilitated. In particular, the present stiffening saddle is provided in addition to a plurality of stiffening bridges that also extend across the rear face and connect the side walls to form separate respective support bridges.

According to a first aspect of the present invention that is provided a jaw crusher jaw support frame comprising: a frame plate having a mounting face for mounting a wear plate and a rear face provided on an opposite side of the frame plate relative to the mounting face, the frame plate having a length and a width; a pair of side walls extending lengthwise along the frame plate, the side walls projecting rearwardly from the rear face; characterised by: at least one stiffening saddle extending widthwise across the frame plate; and a plurality of bore holes extending through the frame plate and the saddle; wherein end regions of the saddle contact respectively the side walls.

Preferably, a distance by which the stiffening saddle extends from the rear face increases at the end regions towards the side walls.

Preferably, the end regions of the stiffening saddle tapper outwardly in a direction rearwardly from the rear face to contact the side walls.

Preferably, a distance by which the stiffening saddle extends from the rear face is less than a distance by which the side walls project rearwardly from the rear face. Optionally, a distance by which the stiffening saddle extends from the rear face is less than a thickness of the frame plate between the mounting face and the rear face.

Preferably, the stiffening saddle extends continuously between the side walls in the widthwise direction over the rear face to form a continuous bridge between the side walls.

Preferably, the end regions of the stiffening saddle tapper outwardly at the region of the side walls in a plane parallel to a plane of the side walls and comprise a concave shape profile at respective junctions between the frame plate and the side walls.

Preferably, a distance by which the stiffening saddle extends from the rear face is substantially uniform between the end regions of the stiffening saddle.

Preferably, the stiffening saddle is formed integrally with the frame plate.

Preferably, the stiffening saddle is positioned towards a first edge of the frame plate that defines a first end of the length of the frame plate.

Preferably, the bore holes are capable of receiving securing members to removably secure a wear plate to the mounting face via a support member.

Optionally, the support frame further comprises a second stiffening saddle, the second stiffening saddle positioned towards a second edge of the frame plate that defines a second end of the length of the frame plate. Optionally, the support frame further comprises a third stiffening saddle positioned at a region between the first and second ends.

Preferably, the side walls and the stiffening saddle are aligned substantially perpendicular to the frame plate.

According to a second aspect of the present invention that is provided a jaw crusher jaw assembly comprising at least one support frame as described herein; at least one wear plate removably mounted at the at least one support frame; and a plurality of securing members extending through the bore holes at the stiffening saddle to releasably secure the wear plate at the mounting face of the frame plate via a support member.

Preferably, the support member is a support bar extending across the mounting face of the support frame.

According to a third aspect of the present invention that is provided a jaw crusher comprising a support frame or jaw assembly as described herein.

### BRIEF DESCRIPTION OF DRAWINGS

A specific implementation of the present invention will now be described by way example only and with reference to the following drawings in which:

FIG. 1 is a perspective view of a jaw crusher unit according to a specific implementation of the present invention;

FIG. 2 is further perspective view of the jaw crusher unit of FIG. 1 with selected components to one side of the crushing zone removed for image clarity;

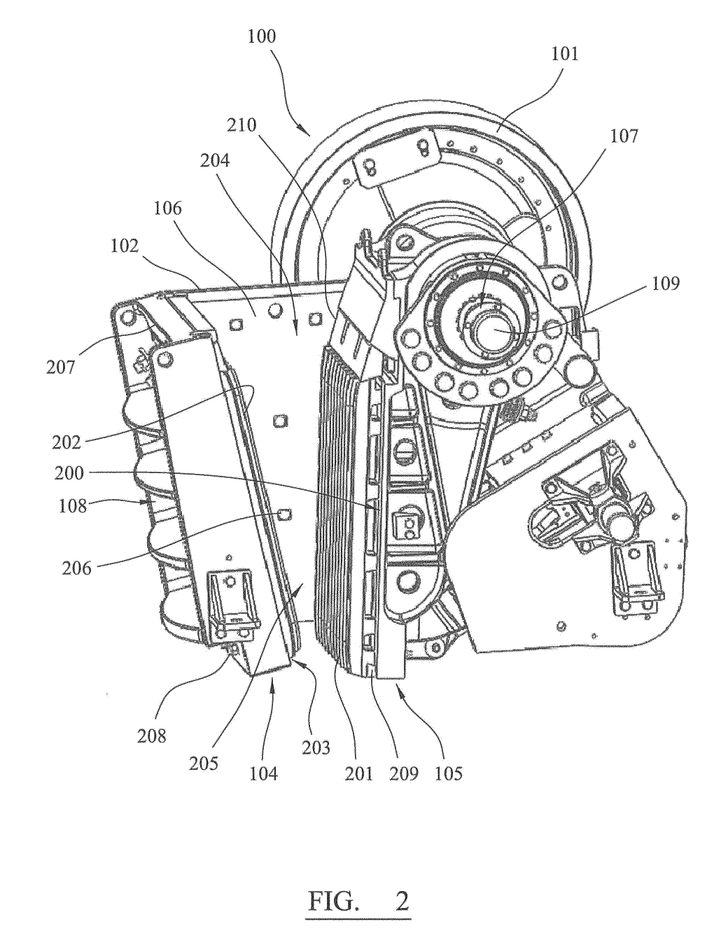

FIG. 3 is a perspective illustration of a jaw support frame having a stiffening saddle extending between a pair of side walls according to a specific implementation of the present invention.

### DETAILED DESCRIPTION OF PREFERRED EMBODIMENT OF THE INVENTION

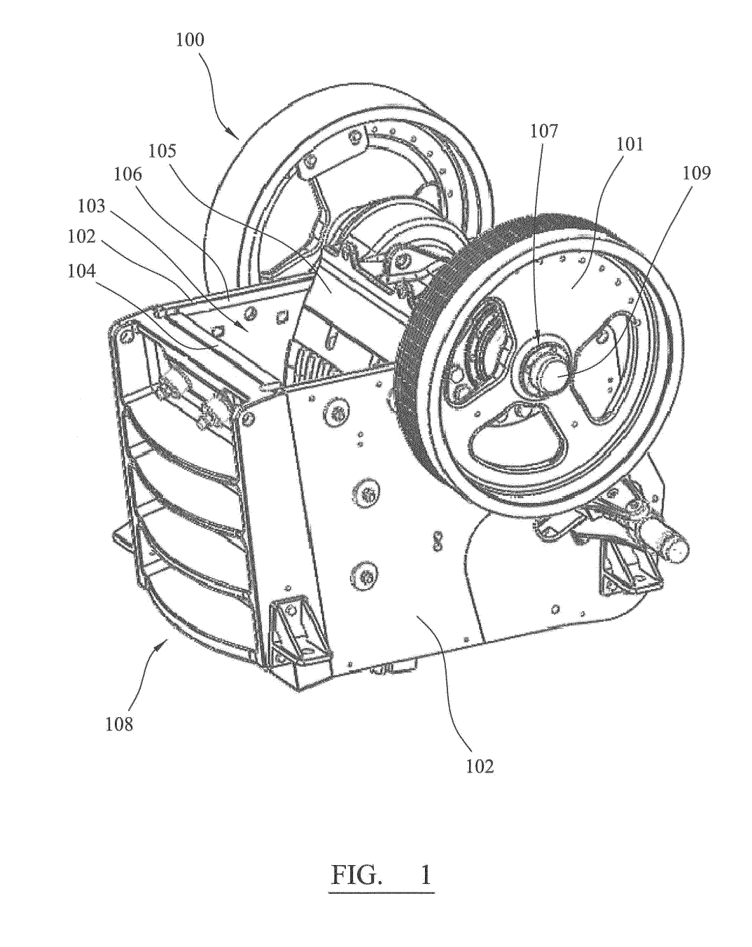

FIG. 1 is a perspective view of a jaw crusher unit 100 having a main frame 102 within which is mounted a substantially planar fixed jaw 104 having a support frame 108. A substantially planar moveable jaw 105 is mounted eccentrically at a rotatable shaft 107 (extending from underneath an end cap 109) and is positioned separated and opposed to fixed jaw 104. The orientation of fixed jaw 104 and moveable jaw 105 relative to one another is convergent along their respective lengths such that a separation distance between a crushing face 203 of fixed jaw 104 and a corresponding crushing face 200 of moveable jaw 105 decreases in the downward lengthwise direction. A suitable wear plate 202 is removably attached to crushing face 203 of the support frame 108 of fixed jaw 104 and a corresponding wear plate 201 is removably attached to crushing face 200 of moveable jaw 105. Main frame comprises two opposed and parallel frame walls 102 that support jaws 104 and 105, which are aligned substantially perpendicular to frame walls 102. Frame walls 102 extend either side of fixed jaw 104 and moveable jaw 105 and collectively define a crushing zone 103.

The opposed fixed and moveable jaws 104, 105 are oriented to be inclined relative to one another and are spaced further apart at their respective upper ends than their lower ends. Accordingly, the crushing zone 103 is convergent from an upper feed region 204 to a lower discharge region 205.

A pair of pulley wheels 101 are mounted either end of shaft 107 at an external facing side of side walls 102 being external to the crushing zone 103. Moveable Jaw 105 is thereby configured for gyroscopic or eccentric motion with respect of fixed jaw 104 as pulley wheels 101 and shaft 107 are rotated via a suitable drive belt (not shown) attached to a drive motor (not shown). This movement of jaw 105 provides the necessary crushing action for material within zone 103 between the opposed wear plates 201 and 202. Material to be crushed is introduced into zone 103 via the open upper region 204 where it is crushed between jaws 104, 105 and subsequently discharged via the open lower region 205. A plurality of removably mounted side liners 106 are attached to each side wall 102 at the region of crushing zone 103 via a plurality of anchorage bolts 206.

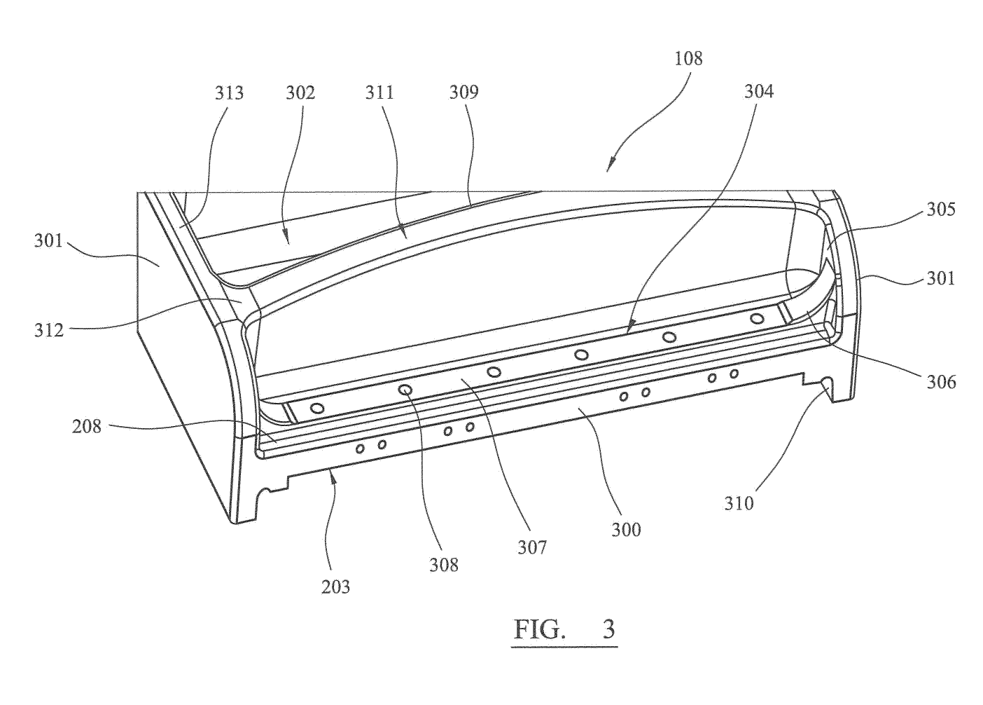

Referring to FIG. 3, the support frame 108 of the fixed jaw 104 comprises a substantially planar frame plate 300 having a length that, together with the moveable jaw 105 defines the length of the crushing zone 103 from upper to lower regions 204, 205. Frame plate 300 also comprises a width aligned perpendicular to its length that, in combination with a width of moveable jaw 105 define a width of the crushing zone 103 between upper and lower regions 204, 205. Frame plate 300 being substantially planar comprises a mounting face 203, to support and mount wear plate 202, and an opposed rear face 302 orientated to be rearward facing away from the crushing zone 103. A pair of side walls 301 extends lengthwise along frame plate 300 between a first end defined by lower edge 208 and a second end defined by upper edge 207. Each side wall 301 is aligned substantially perpendicular to frame plate 300 and projects generally rearwardly from rear face 302. A respectively short section 310 of side walls 301 also extends forwardly from support surface 203 to be positioned adjacent side edges of wear plate 202 when mounted in position at support frame 108. A distance by which side walls 301 extends from rear face 302 is several multiples of the thickness of frame plate 300 between support face 203 and rear face 302.

To increase the stiffness of the support frame 108, four stiffening bridges 309 extend widthwise across frame plate 300 between and connecting side walls 301. The stiffening bridges 309 comprise a curved rearmost edge 311 with end regions 312 aligned at end edges 313 of side walls 301. That is, a distance by which stiffening bridges 309 extend from rear face 302 is approximately equal to a distance by which side walls 301 extend from rear face 302.

To further increase the stiffness of frame 108, a stiffening saddle 304 extends widthwise across frame plate 300 between side walls 302. Saddle 304 also projects rearwardly from rear face 302 and forms a continuous uninterrupted bridge between side walls 301. In particular, end regions 306 of saddle 304 are connected in touching contact with opposed inner facing surfaces 305 of side walls 301.

A distance by which saddle 304 extends from rear face 302 is at least one order of magnitude and in particular many orders of magnitude less than the corresponding distance by which stiffening bridges 309 extend from rear face 302. Accordingly, saddle 304 extends from rear face 302 by a relatively small distance compared to the corresponding distance by which bridges 309 and side walls 301 extend.

A plurality of bore holes 308 extend through frame plate 300 and saddle 304 such that an axis of each hole 308 is aligned perpendicular to the plane of support plate 300. Bore holes 308 are configured to receive the anchorage bolts that secure a support bar 209 to crushing face 200. With respect to the fixed jaw, wear plate 202 is secured to support frame 108 towards the upper and lower regions 207, 208 relative to crushing zone 103 by an upper wedge 210 (illustrated at the moveable jaw 105) that acts to squeeze wear plate 202 against the lower support bar 209 (illustrated at the moveable jaw 105) that is aligned generally perpendicular to a main length of wear plate 202. The same mechanism for attachment is also provided to secure the corresponding wear plate 201 to the moveable jaw 105. Accordingly, the saddle 304 illustrated in FIG. 3 is positioned towards the lower or first edge end 208 of plate 300.

To increase the contact surface area between saddle 304 and side walls 301, the end regions 306 of saddle 304 are tapered in the projecting direction of side walls 301 substantially perpendicular to frame plate 300. The tapered end regions 306 are generally curved at the junction between rear face 302 and the inner facing surfaces 305 of side walls 301. Accordingly, the concave rearwardly projecting end regions 306 comprise a reducing thickness in the plane of side walls 301 such that the very rearward most portion of end regions 306 fades seamlessly into respective surfaces 305. Accordingly, a cross section of saddle 304 in a plane perpendicular to the plane of support plate 300 comprises a generally U-shaped profile.

A central ‘cross bar’ region 307 of saddle 304 that extends between end regions 306 is substantially uniform along its length across the width of support plate 300. In particular, a depth of cross bar 307 (in a plane parallel to side walls 301) and a thickness of cross bar 307 (in a plane parallel to support plate 300) is substantially constant between end regions 306.

According to further specific implementations, the support frame 108 comprises a second saddle 304 positioned towards second edge end 207. According to a further embodiment, support frame 108 comprises a third saddle 304 positioned at a region between the first and second saddles respectively positioned at ends 208, 207. According to yet further embodiments, one or a plurality of stiffening saddles 304 are provided on a corresponding support frame of moveable jaw 105.

1. A jaw crusher jaw support frame comprising:
a frame plate having a mounting face for mounting a wear plate and a rear face provided on an opposite side of the frame plate relative to the mounting face, the frame plate having a length and a width;
a pair of side walls extending lengthwise along the frame plate, the side walls projecting rearwardly from the rear face;
at least one stiffening saddle extending widthwise across the frame plate; and
a plurality of bore holes extending through the frame plate and the saddle, wherein end regions of the saddle contact respectively the side walls.

2. The support frame as claimed in claim 1, wherein a distance by which the stiffening saddle extends from the rear face increases at the end regions towards the side walls.

3. The support frame as claimed in claim 1, wherein the end regions of the stiffening saddle tapper outwardly in a direction rearwardly from the rear face to contact the side walls.

4. The support frame as claimed in claim 1 wherein a distance by which the stiffening saddle extends from the rear face is less than a distance by which the side walls project rearwardly from the rear face.

5. The support frame as claimed in claim 1, wherein the stiffening saddle extends continuously between the side walls in the widthwise direction over the rear face to form a continuous bridge between the side walls.

6. The support frame as claimed in claim 1, wherein the end regions of the stiffening saddle tapper outwardly at the region of the side walls in a plane parallel to a plane of the side walls and have a concave shape profile at respective junctions between the frame plate and the side walls.

7. The support frame as claimed in claim 1, wherein a distance by which the stiffening saddle extends from the rear face is substantially uniform between the end regions.

8. The support frame as claimed in claim 1, wherein the stiffening saddle is formed integrally with the frame plate.

9. The support frame as claimed in claim 1, wherein the stiffening saddle is positioned towards a first edge of the frame plate that defines a first end of the length of the frame plate.

10. The support frame as claimed in claim 9, further comprising a second stiffening saddle, the second stiffening saddle being positioned towards a second edge of the frame plate that defines a second end of the length of the frame plate.

11. The support frame as claimed in claim 10, further comprising a third stiffening saddle positioned at a region between the first and second ends.

12. The support frame as claimed in claim 1, wherein the side walls and the stiffening saddle are aligned substantially perpendicular to the frame plate.

13. A jaw crusher jaw assembly comprising:
at least one support frame including a frame plate having a mounting face for mounting a wear plate and a rear face provided on an opposite side of the frame plate relative to the mounting face, the frame plate having a length and a width, a pair of side walls extending lengthwise along the frame plate, the side walls projecting rearwardly from the rear face, at least one stiffening saddle extending widthwise across the frame plate, and a plurality of bore holes extending through the frame plate and the saddle, wherein end regions of the saddle contact respectively the side walls;
at least one wear plate removably mounted at the at least one support frame; and
a plurality of securing members extending through the bore holes at the stiffening saddle to releasably secure the wear plate at the mounting face of the frame plate via a support member.

14. A jaw crusher comprising:
a support frame including a frame plate having a mounting face for mounting a wear plate and a rear face provided on an opposite side of the frame plate relative to the mounting face, the frame plate having a length and a width, a pair of side walls extending lengthwise along the frame plate, the side walls projecting rearwardly from the rear face, at least one stiffening saddle extending widthwise across the frame plate, and a plurality of bore holes extending through the frame plate and the saddle, wherein end regions of the saddle contact respectively the side walls; and
a jaw assembly having at least one wear plate removably mounted on at the at least one support frame, and a plurality of securing members extending through the bore holes at the stiffening saddle to releasably secure the wear plate at the mounting face of the frame plate via a support member.
